(19) United States
(12) Patent Application Publication
(10) Pub. No.: US 2014/0184898 A1
(43) Pub. Date: Jul. 3, 2014

(54) ELECTRONIC DEVICE

(71) Applicant: Tetsuwan Pty Ltd, Melbourne (AU)

(72) Inventors: Ian Overliese, South Yarra (AU); Jeromy Michael Young, Richmond (AU); Daniel John Elleson, South Yarra (AU)

(73) Assignee: Tetsuwan Pty Ltd, Melbourne (AU)

(21) Appl. No.: 14/200,971

(22) Filed: Mar. 7, 2014

Related U.S. Application Data
(63) Continuation of application No. PCT/AU2012/001063, filed on Sep. 7, 2012.

(30) Foreign Application Priority Data
Sep. 8, 2011 (AU) 2011903665

(51) Int. Cl. H01M 2/10; H04N 5/225

(52) U.S. Cl. CPC H01M 2/1055; H04N 5/2251
USPC 348/372

(57) ABSTRACT

A video conversion device, containing electronic circuitry for conversion of a High Definition Multimedia Interface (HDMI) signal fed through input terminal to a Serial Digital Interface (SDI) signal which is outputted through output terminals, is connected to a conventional video camera battery pack. The body has four L-shaped slideway formations to receive slides on a battery plate to form a push-on physical connection with the camera. One side of the body is recessed, with four lugs or slide formations complementary to the slideway formations, at the edges of the recess, to be fitted into the slideways formed in the base of the battery pack to the slideway slots in the conversion device, and the battery pack can be quickly fitted to the conversion device via a push-on connection. The battery pack supplies power to the circuitry of the conversion device through terminals which is then supplied to the camera.

### TECHNICAL FIELD

This invention relates to electronic devices and has particular but not exclusive application to electronic equipment used in capturing, monitoring, recording and transmitting video and audio material. Such equipment may be used professionally in studios or in the field or may be sold and used as consumer equipment.

Video cameras and other equipment used in association with video cameras (such as motorised mounting devices, lights and monitors) are often battery powered using battery packs which can be mounted directly on the equipment through push-on connections provided by interfitting formations on the battery packs and the respective items of equipment. Accordingly, each of these items is usually powered by a separate battery which, once the battery is depleted, must be replaced by another battery during which time the device will be without power. One embodiment of the invention enables a simplification and improvement in the battery powering of such equipment.

Various other devices may be used to modify video and audio material produced by video cameras, for example for video conversion, audio amplification, audio embedding and de-embedding, transfer of control and timing information. These devices will typically be separate from the video camera and connected to it by an electrical cable for transmission of the video or audio material from the video camera to the device.

Video conversion devices convert video or video and audio information from one electrical signal form to another, typically from High-Definition Multimedia Interface (HDMI) to Serial Digital Interface (SDI) or high-definition serial digital interface (HD-SDI) or analogue signals. SDI and HD-SDI are currently only available in professional equipment and expensive consumer cameras and equipment operating on HDMI. Current video electrical connection formats often include audio signals in the same cable and many video conversion devices therefore also insert or extract separate audio signals as part of their conversion operations.

Several conversion or other signal modification devices may be required for use in association with a video camera or other equipment. At present those devices, when connected to video recording device by electrical cables, are located in an ad hoc manner, for example by tying or taping to a camera tripod, fixing to a tripod with Whitworth tripod screws or sitting on a bench. Other embodiments of the present invention allow for much more convenient location and mounting of the ancillary devices on or adjacent the equipment with which they are being used.

### SUMMARY OF THE INVENTION

In accordance with one embodiment of the invention there may be provided an electronic device comprising a body containing electronic circuitry and provided with a connector formation to enable the device to be physically connected to a structure provided with a complementary formation by a push on connection.

The connector formation on the device may comprise a plurality of slideways adapted to receive complementary slide formations to form the push-on connection.

According to another aspect, the invention may provide for use with battery powered electronic equipment provided with a primary connector formation capable of connecting through a push-on connection with a battery pack provided with a secondary connector formation complementary to the primary formation, an electronic device comprising a body containing electronic circuitry adapted to be connected to the electronic equipment and provided with a secondary connector formation complementary to the primary connector formation of said equipment to enable the electronic device to be physically connected to that equipment by a push-on connection by interfitting the primary and secondary formations.

The device may include an internal battery to power said electronic equipment when the device is physically connected to that equipment by the push-on connection.

The primary connector formation may comprise a plurality of slides and the secondary connector formation may comprise a plurality of slideways to receive the slides of the primary formation.

The slideways may be generally L-shaped.

The secondary connector formation of the device may be formed at one side of the body of the device and another side of the body may be provided with a primary connector formation for connection with a battery pack or another electronic device provided with a complementary connector formation.

In another aspect the invention may provide in combination:
an item of battery powered electronic equipment;
a first power supply device physically connectable to said item of electronic equipment by a first push-on connection formed by interfitting formations on said item of equipment and the first power supply device and containing a first battery to power said item of electronic equipment;
a second power supply device physically connectable to said first power supply device by a second push-on connector and containing a second battery to power said item of electronic equipment and to charge the first battery in the first power supply device;

whereby on depletion or removal of the second battery the electronic equipment continues to be powered by the internal battery of the first power device.

The above combination may include electronic circuitry to switch power supply to the item of electronic equipment from the second battery to the first battery when the second battery becomes depleted or is removed.

The switching circuitry may be incorporated into the first power device.

The invention further extends to an electronic device comprising a body containing electronic circuitry and physically connected to a structure by a push-on connection between a connector formation on the electronic device and a complementary connector formation on said structure.

Said structure may be a body of a video camera or other item of electronic equipment or it may be a rack for locating a plurality of electronic devices.

### BRIEF DESCRIPTION OF THE DRAWINGS

In order that the invention may be fully explained some particular embodiments will be described in some detail with reference to the accompanying drawings in which

FIG. 1 is a perspective view of a video conversion device constructed in accordance with the invention;

FIG. 2 is an underneath view of the conversion device shown in FIG. 1;

FIG. 3 is a further perspective view of the conversion device when fitted with a conventional battery pack;

FIGS. 4(a) and 4(b) show electrical circuitry for switching a power supply from an external battery to an internal battery within a device constructed in accordance with the invention;

FIG. 5 illustrates a stack of three electronic devices constructed in accordance with the invention and fitted with a single battery pack; and

FIG. 6 illustrates a series of devices mounted on a rack.

### DESCRIPTION OF PREFERRED EMBODIMENTS

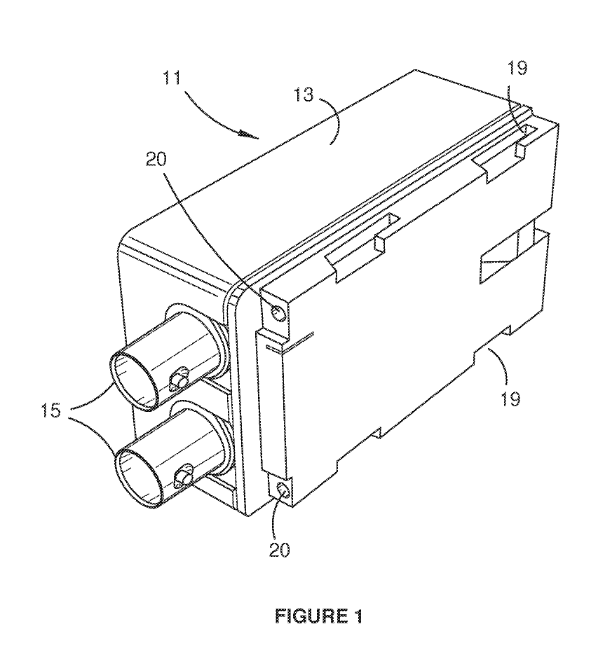

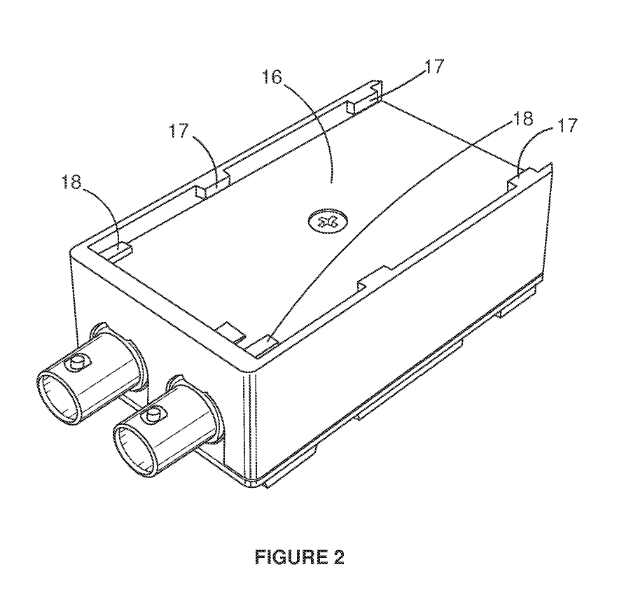

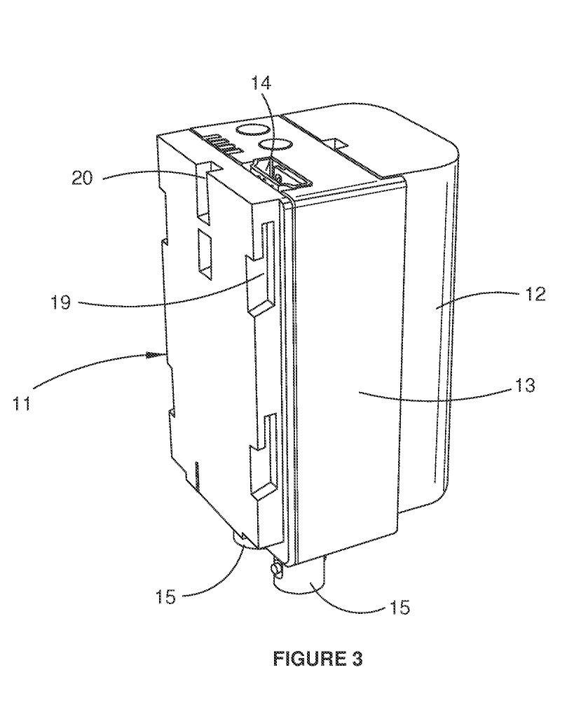

The video conversion device illustrated in FIGS. 1 to 3 is denoted generally as 11 and it is shown in FIG. 3 connected to a conventional video camera battery pack 12. Device 11 comprises a rectangular block shaped body 13 of generally similar proportions to the battery pack 12. Body 13 houses electronic circuitry for conversion of an HDMI signal fed through input terminal 14 to an SDI signal which is outputted through output terminals 15.

One side of body 13 is provided with four L-shaped slideway formations 19 designed to receive slides on a battery plate of a video camera (not shown) to form a push-on physical connection with the camera. The other side of body 13 is recessed at 16 and provided at the edges of the recess with four lugs or slide formations 17 which are complementary to the slideway formations 19 and identical to the formations of the video camera battery connection plate. Accordingly they can be fitted into the slideways formed in the base of battery pack 12 in identical fashion to the slideway slots 19 in the conversion device. Accordingly the battery pack 12 can be quickly fitted to the conversion device 13 via a push-on connection and the conversion device similarly fitted to the camera battery plate by another push-on connection. The battery pack supplies power to the circuitry of the conversion device through terminals 18 and power is supplied via the conversion device to the camera through terminals 20.

Conversion device 13 may also be fitted with an internal rechargeable battery (not shown) together with circuitry so that the internal battery is charged when the external battery pack 12 is fitted. The conversion device 11 can then supply power to power the camera, recorder or other device to give uninterrupted operation even when the external battery pack is removed, for example when in changing or charging the battery pack when it is depleted.

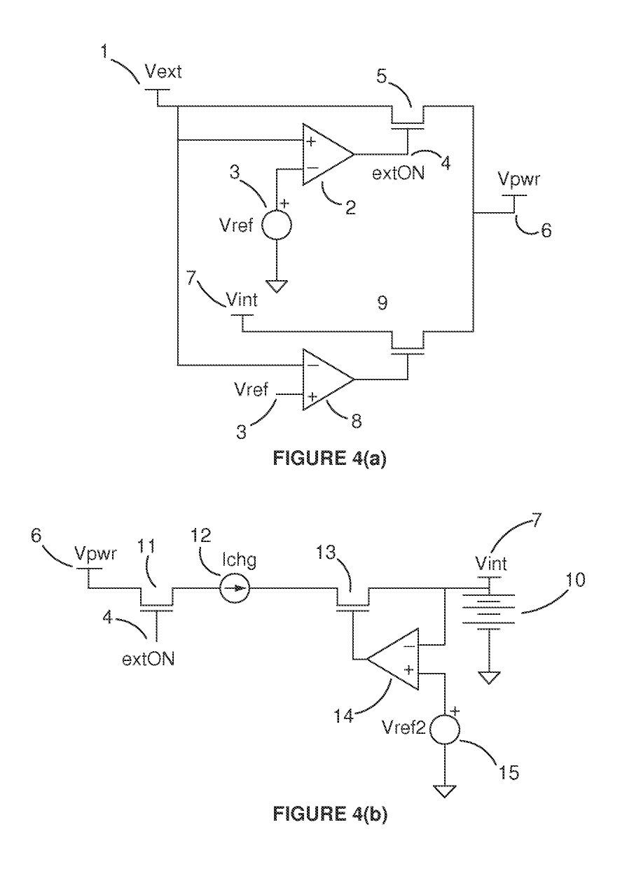

FIGS. 4 and 4(a) illustrate electric circuitry which may be incorporated into the circuitry of the conversion device to cause switching of the power supply from the external battery pack to the internal battery of the conversion device. The circuit depicted at FIG. 4(a) is an example of a circuit whose purpose is to choose whether the external power supply Vext at 1 or the power supply Vint at 7, which is connected to the internal battery at 10, is connected to the output power connection Vpwr at 6.

The operation of the circuit at 4(a) is thus described: The voltage present at the external voltage supply Vext at 1 is compared using comparator 2 with a voltage reference Vref at 3. In the most common operation, the voltage Vref will be set to the desired voltage where Vext is considered to be a satisfactory voltage for supplying Vpwr. When the voltage Vext at 1 is below Vref at 3, the comparator at 2 drives the node extON at 4, to cause the switching element at 5 to turn off, i.e. disconnect Vext 1 from Vpwr 6. Conversely, when the voltage Vext at 1 is greater than Vref at 3, the comparator at 2 drives the note extON at 4, to cause the switching element at 5 to turn on.

The comparator at 8, compares the external voltage Vext at 1, to the same Vref at 3, but is set to operate such that the switching element at 9 is turned on when the voltage Vext at 1 is below Vref at 3, and the switching element at 9 is turned off when the voltage Vext at 1 is above Vref at 3.

The charging of the internal battery at 10 from the external supply Vext at 1, may be accomplished with a circuit such as that shown in FIG. 4(b). The example shown at 4(b) is the typical kind of circuit for a standard single stage lithium ion battery charger. When the comparator depicted in FIG. 4(a) at 2 senses that the voltage Vext at 1 is greater than the reference voltage Vref at 3, it turns on the switching element 5 to connect Vext at 1 to Vpwr at 6. At the same time as this is occurring, the comparator at 8 turns off the switching element 9, to isolate Vint at 7 from Vpwr at 6. The node extON at 4, may then also be used to turn on another switching element at 11, to connect Vpwr at 6 to a current source at 12, which is connected via another switching element at 13, to the internal battery at 10. The switching element at 13 is controlled by a comparator at 14 which compares the internal battery voltage Vint at 7, with the reference voltage Vref2 at 15, in order to cause the switching element at 13 to be turned off when the voltage Vint at 7 is greater than the voltage Vref2 at 15. Vref2 at 15 would normally be selected such that it represents a satisfactorily charged voltage for the battery at 10.

The circuits shown at 4(a) and 4(b) are indicative examples of the selection and charging functions for a dual supply and battery charging system. There are many other established methods and circuits for performing these functions, and there also exist many monolithic devices for achieving such functions.

A conversion device such as that shown in FIGS. 1 to 3 can be quickly connected onto an HDMI video camera by a very sturdy connection and provide conversion to SDI, from which it is possible to run cable for long distances. It accordingly effectively converts a relatively cheap camera to one of upgraded capability which is normally only available in much more expensive cameras.

In another embodiment of the invention a device may be provided with an external physical form the same as that of the device illustrated in FIGS. 1 to 3 but may lack signal conversion circuitry so as to have no function other than the power supply function. In this form the device will still offer the continuous power operation advantage. If the external battery is removed the device will supply power to the camera or other equipment and when the battery pack is replaced it may be used by the device to recharge its internal battery and feed power from the external battery pack via the device to the appropriate equipment.

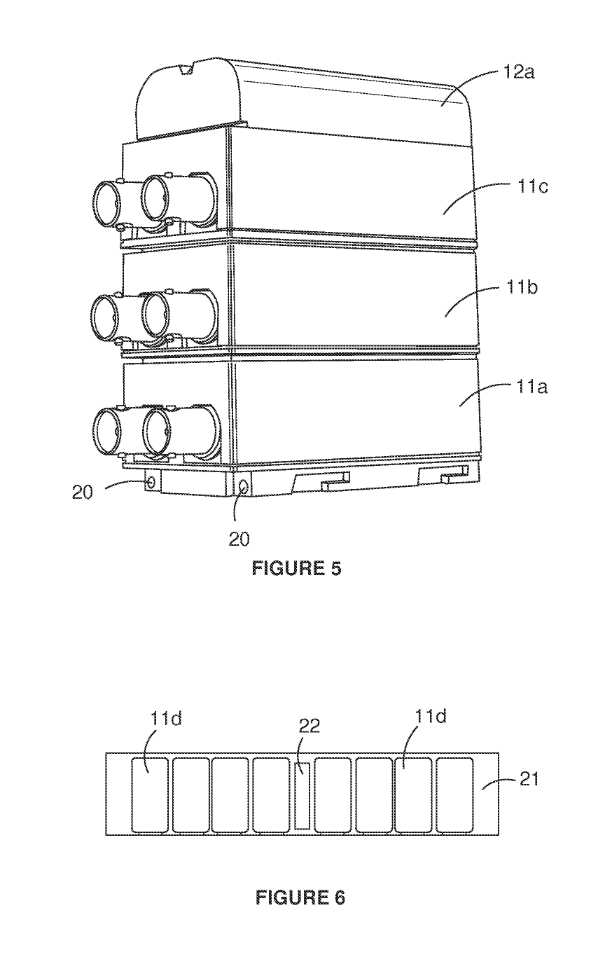

Instead of providing a single conversion device connected directly to a battery pack as shown in FIGS. 1 to 3 a series of similarly formed devices 11a, 11b, 11c may be connected together in a stack and to a single battery pack 12a as shown in FIG. 5. The devices 11a, 11b, 11c have the same external physical characteristics as the conversion device 11 and the respective slide and slideway formations can be used to form the interconnections between them. The internal circuitry of devices 11a, 11b, 11c may vary according to the function which the device is to perform. For example the stack of devices could be fitted to a video camera and used for video conversion, audio embedding and de-embedding and monitor control and may or may not have an internal battery.

Devices in accordance with the invention may provide conversion either way between HDMI and SDI or HD-SDI or between analogue video and HDMI or SDI/HD-SDI according to particular applications, for example display, recording and provision of audio/visual links.

Devices according to the invention may also be provided with electronic circuitry for the purpose of sending signals to electronic equipment to which they are attached or to other electronic equipment, for example within a television studio, to enable the electronic equipment and/or the other equipment to be controlled, monitored and/or synchronised or to receive an audio or video signal from an external device.

The external form of the devices 11 in FIGS. 1 to 3 and 11a-11c of FIG. 5 also enables them to be mounted side by side on a longitudinal rack fitted with slide formations in the same manner as the series of battery pack mount plates disposed side by side along the rack in the manner shown diagrammatically in FIG. 6. In that case a series of devices 11d fitted to the rack 21 could be charged through a single AC-DC converter 22 disposed in the middle of the rack.

1. An electronic device for use with battery powered electronic equipment provided with a primary connector formation capable of connecting through a push-on connection with a battery pack provided with a secondary connector formation complementary to the primary formation, the electronic device comprising a body containing electronic circuitry adapted to be connected to the electronic equipment and provided with a secondary connector formation complementary to the primary connector formation of said equipment to enable the electronic device to be physically connected to that equipment by a push-on connection by interfitting the primary and secondary formations, wherein the electronic circuitry performs processing on a video and/or audio signal.

2. A device as claimed in claim 1 wherein the primary connector formation comprises a plurality of slides and the secondary connector formation comprises a plurality of slideways to receive the slides of the primary formation.

3. A device as claimed in claim 2 wherein the slideways are generally L-shaped.

4. A device as claimed in claim 1 wherein the secondary connector formation of the device is formed at one side of the body of the device and another side of the body is provided with a primary connector formation for connection with a battery pack or another electronic device provided with a complementary connector formation.

5. A device as claimed in claim 4 wherein the primary connector formation on the device is the same shape as the primary connector formation on the electronic equipment.

6. A device as claimed in claim 4 wherein, when a battery pack is connected to the device by the primary connector formation, the electronic circuitry is adapted to enable the battery pack to power the device and the electronic equipment.

7. A device as claimed in claim 4 wherein, when a battery pack is connected to the device by the primary connector formation, the electronic circuitry is adapted to enable the battery pack to charge a battery within the device which battery is adapted to power the device and the electronic equipment.

8. A device as claimed in claim 1 wherein the electronic circuitry is for modifying signals received from or passing to the electronic equipment or other electronic equipment.

9. A device as claimed in claim 1 wherein the electronic circuitry provides power for other electronic circuitry.

10. A device as claimed in claim 1 wherein the electronic circuitry provides wired or wireless communications to the electronic equipment or other electronic equipment.

11. A device as claimed in claim 1 wherein the electronic circuitry sends signals to the electronic equipment or other electronic equipment.

12. A device as claimed in claim 11 wherein the electronic circuitry sends signals to the electronic equipment or other electronic equipment to enable the electronic equipment or other electronic equipment to be controlled by and/or monitored by separate electronic equipment.

13. A device as claimed in claim 12 wherein the electronic circuitry sends signals to the electronic equipment or other electronic equipment to enable the electronic equipment or other electronic equipment to be synchronised with the separate electronic equipment.

14. A device as claimed in claim 12 wherein the electronic circuitry sends signals to the electronic equipment or other electronic equipment to enable the electronic equipment or other electronic equipment to receive an audio or video signal from an external device.

15. A device as claimed in claim 1 which includes an internal battery to power said electronic equipment when the device is physically connected to that equipment by the push-on connection.

16. In combination
an item of battery powered electronic equipment;
a first power supply device physically connectable to said item of electronic equipment by a first push on connection formed by interfitting formations on said item of equipment and the first power supply device and containing a first battery to power said item of electronic equipment;
a second power supply device physically connectable to said first power supply device by a second push on connector and containing a second battery to power said item of electronic equipment and to charge the first battery in the first power supply device;
whereby on depletion or removal of the second battery the electronic equipment continues to be powered by the internal battery of the first power device.

17. A combination as claimed in claim 16 including electronic circuitry to switch power supply to the item of electronic equipment from the second battery to the first battery when the second battery becomes depleted or is removed.

18. A combination as claimed in claim 17 wherein the switching circuitry is incorporated into the first power device.

19. A combination as claimed in claim 16 wherein the first power device incorporates electronic circuitry for electrical connection to the item of electronic equipment.

20. A combination as claimed in claim 19 wherein the electronic circuitry is for modifying signals received from or passing to the said item of electronic equipment or other electronic equipment.

21. An electronic device comprising a body containing electronic circuitry and physically connected to a structure by a push-on connection between a connector formation on the electronic device and a complementary connector formation on said structure, wherein said structure is an elongate rack provided with longitudinally spaced sets of complementary connector formations and said device is one of a plurality of devices fitted to the rack through push-on connections by connecting connector formations of the devices to complementary connector formations of the rack.

22. The combination claimed in claim 21 wherein the connector formation on the electronic device comprises a plurality of slideways and the complementary connector formation on said structure comprises a plurality of slides fitted into the slideways.
